(19) United States
(12) Patent Application Publication
(10) Pub. No.: US 2018/0357143 A1
(43) Pub. Date: Dec. 13, 2018

(54) TESTING COMPUTING DEVICES

(71) Applicant: HEWLETT PACKARD DEVELOPMENT COMPANY, L.P., Houston, TX (US)

(72) Inventors: Deepak PANAMBUR, Bangalore (IN); Pavan SRIDHAR, Bangalore (IN); K. Sreeramulu THEJOVATHI, Bangalore (IN); Bishnubiva PRADHAN, Bangalore (IN)

(21) Appl. No.: 15/736,770

(22) PCT Filed: Jul. 27, 2015
(86) PCT No.: PCT/IN2015/050077

§ 371 Date: Dec. 14, 2017

(51) Int. Cl. G06F 11/26; G06F 11/22

(52) U.S. Cl. CPC G06F 11/26; G06F 11/2289

(57) ABSTRACT

Aspects of testing computing devices are described. In an example, a set of logical modules associated with a test case for a component of a computing device being tested is executed using testing information for testing the component. Each logical module in the set of logical modules comprises instructions that, when executed, performs a set of predefined tasks for testing component. Further, a test log is generated upon execution of the set of logical modules.

### BACKGROUND

Testing of a computing device involves testing several components associated with the computing device. The components that may be tested include, for example, a processor, a memory, a card, a fan, and a port of the computing device. Testing of such components at various points in time during the lifetime of the components facilitates in identifying probable faults and taking remedial action.

### BRIEF DESCRIPTION OF FIGURES

The detailed description is described with reference to the accompanying figures. The description and figures are merely examples of the present subject matter and are not meant to define the scope of the subject matter as claimed.

FIG. 1 illustrates a system for testing computing devices, according to an example of the present subject matter;

FIG. 2 illustrates a network environment implementing a system for testing computing devices, according to an example of the present subject matter;

FIG. 3 illustrates a system for testing computing devices, according to an example of the present subject matter;

FIG. 4 illustrates a framework for testing computing devices, according to an example of the present subject matter;

FIG. 5 illustrates a method for testing computing devices, according to an example of the present subject matter;

FIG. 6 illustrates a method for testing computing devices, according to an example of the present subject matter; and

FIG. 7 illustrates a computer readable medium for testing computing devices, according to an example of the present subject matter.

### DETAILED DESCRIPTION

Components of a computing device, for example, processors, memory, and motherboards, may be tested for varied reasons. For instance, a component may be tested for verifying proper functioning of the component. In another example, the component may be tested to determine a maximum load that the component can handle.

Testing of such a component, in general, involves execution of one or more test cases on the component. A test case may include information and instructions for conducting a test on the component. For instance, a test case may include a set of conditions based on which the component may be tested, input data for testing the component, expected output data, and steps for conducting the one or more tests. Based on the outcomes of the test cases, the component's performance may be rated as being equal to or better than an expected performance or less than the expected performance.

In one typical approach, testing of components is performed manually, i.e., an individual, for example, a tester, is assigned with the task of testing the components. In said approach, for testing a component, the individual, at first, has to create a test case and then execute the steps specified in the test case for testing the component. Subsequently, the individual can record the outcome of the test case and validate the outcome for ascertaining a performance of the component. As such an approach of testing is manually driven, it can be a time consuming and cumbersome task. For instance, creation of the test case, i.e., determining the input data, the expected output, and the test steps and conditions may involve multiple iterations and expert knowledge. Further, in cases where a large number of components have to be tested, creation of the test cases at a large scale may increase the complexity of the task and thereby the time and skills involved. Further, the tester has to be suitably trained to execute the test case. Additionally, manual testing is susceptible to inadvertent human errors and thus, may result in an incorrect assessment of a component's performance.

In another typical approach, testing of the components may be partly automated. For instance, once the test cases are created by a tester, a script for each of the test cases may be created by an individual for executing the test cases on the component. The script associated with a test case may include instructions for executing the steps specified in the test case. Such an approach reduces the manual intervention associated with testing of the components. However, creation of the test cases, for reasons explained above, may still be inefficient. Further, as each of the scripts is specific to a test case, it may warrant inclusion of detailed instructions for executing the test case. Thus, creation of the scripts may prove to be a time consuming and complex task. Additionally, as the scripts are component specific, they may not be usable across different models of a component or across different components. Thus, in a case where different models of a component or different components are to be tested, the scripts may have to be redesigned. Redesigning of the scripts may again prove to be time consuming and error prone.

The present subject matter relates to automation in testing of computing devices. According to an aspect, creation and execution of a test case may be automated by allowing association of a set of logical modules with the test case. A logical module, as described herein, may include instructions for executing a set of predefined tasks to perform one or more steps of a test case on the component under test. The set of logical modules associated with the test case may be selected from a plurality of logical modules. Thus, depending upon an objective of the test case, a suitable set of logical modules may be associated with the test case. As a result, time duration and errors associated with creation and execution of the test cases may be substantially reduced.

In an implementation, a system deployed for testing components of a computing device may be provided with testing information. The testing information may include network location information, for example, an Internet Protocol (IP) address, and a gateway, associated with the computing device. Additionally, the testing information may include other information, such as information about an operating system of the computing device and a model and type of a component which is to be tested.

Using the testing information, the system may connect to the computing device to be tested and determine the component which is to be tested. The system may then identify a test case to be executed on the component. In an implementation, the test case may be determined based on a user input. For example, the system may provide the user with a list of pre-defined test cases that may be executed on the component. In response, the system may receive a selection of the test case from the user. In another example, the system may create a new test case based on the user input. In said example, the user input may include a set of logical modules selected by the user from the plurality of logical modules for being associated with the test case. In another implementation, the test case may be identified based on the type of the component, i.e., the system may include pre-defined test cases for various components of the computing device and may automatically select the test case based on the testing information and the component to be tested. As can be seen, creation of the test case is achieved in a simplified manner and, as a result, the time duration and complexity associated with creation of the test cases is reduced.

Once the test case to be executed is identified, the system may retrieve the set of logical modules associated with the test case for executing the test case. As mentioned above, each logical module may include instructions for performing a set of predefined tasks in order to test the component. Thus, for testing the component, the system may execute the instructions included in each of the logical modules present in the set of logical modules. In an example, for facilitating execution of the logical modules, the system may retrieve one or more configuration files and library files from a data source based on the testing information.

In response to the execution of the set of logical modules, the computing device may generate an output that indicates operational behavior of the component when the logical modules are being executed. Based on the output, the system may generate a test log. In an example, the system may validate the test log for ascertaining a performance of the component. In an example, the system may validate the test log based on a comparison with validation data associated with the component. The validation data may include, for example, expected performance output of the component when operated under a plurality of operation conditions. Based on the validation of the test log, a test report indicative of the performance of the component may be generated by the system. The system may then provide the test report to the user for further action.

As the creation of a test case is achieved by selecting one or more logical modules from the plurality of logical modules, the time duration and complexity associated with the creation of the test case may be reduced. Further, as the logical modules are independent of the component being tested, the same logical module may be used for performing the associated set of predefined tasks on different models of the same component or different components. Thus, redesigning of the logical modules for testing different components is averted thereby making the testing of components less cumbersome and less dependent on the skills of the individual performing the testing.

The above aspects are further described in conjunction with figures and associated description below. It should be noted that the description and figures merely illustrate the principles of the present subject matter. Therefore, various arrangements that embody the principles of the present subject matter, although not explicitly described or shown herein, can be devised from the description and are included within its scope.

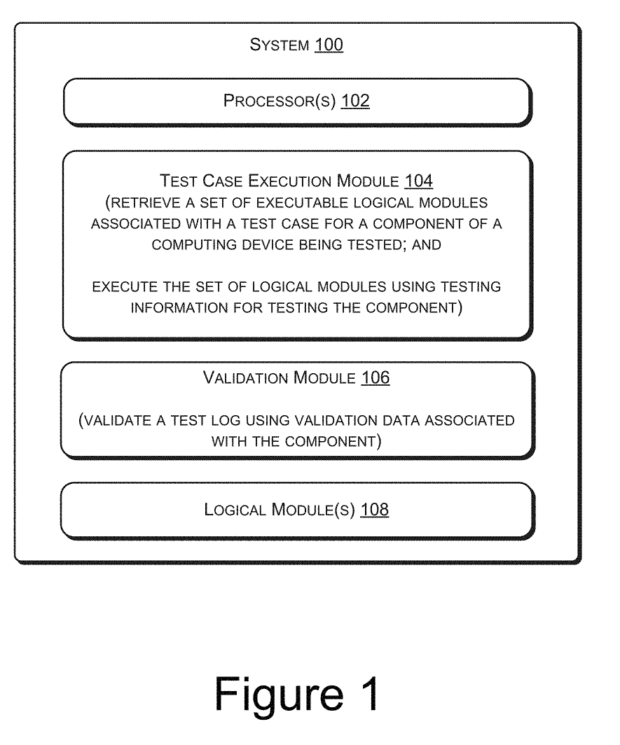

FIG. 1 illustrates a system 100 for testing computing devices, in accordance with an example of the present subject matter. The system 100 may be implemented as one or more computing systems, such as personal computers, laptops, desktops, servers, and the like. In an example, the system 100 may include processor(s) 102. The processor(s) 102 may be implemented as microprocessors, microcomputers, microcontrollers, digital signal processors, central processing units, state machines, logic circuitries, and/or any devices that manipulate signals based on operational instructions. Among other capabilities, the processor(s) 102 fetch and execute computer-readable instructions stored in a memory. The functions of the various elements shown in the figure, including any functional blocks labeled as “processor(s)”, may be provided through the use of dedicated hardware as well as hardware capable of executing machine readable instructions.

The system 100 may further include a test case execution module 104, a validation module 106, and a plurality of logical modules 108, collectively referred to as logical modules 108 and individually referred to as logical module 108. In accordance with the present subject matter, each logical module 108 may include instructions that, when executed, perform a set of predefined tasks for testing a component. In an example, the test case execution module 104, the validation module 106, and the logical modules 108 are coupled to the processor(s) 102.

The system 100 may be deployed for testing a plurality of computing devices (not shown in the figure), for example, a laptop, a desktop, a printer, a scanner, a workstation computer, a server, and the like. Testing of a computing device may involve testing one or more components thereof.

In operation, the system 100 may receive testing information, from a user, for testing a component of a computing device. In an example, the testing information may include network location information associated with the computing device. Based on the network location information, the system 100 may establish a connection with the computing device. Further, the testing information may include information associated with an operating system of the computing device and information about the component to be tested. In one example, the user may specify the component to be tested as part of the testing information. In another example, upon establishing the connection with the computing device, the system 100 may discover which components that can be tested are present in the computing device and may provide the list of the components to the user. The user may then select the components to be tested. The system 100 may store the user selection as part of the testing information.

In an example, for testing the component, the system 100 may identify a test case to be used based on at least one of a user input and a type of the component. Subsequently, the test case execution module 104 may retrieve a set of executable logical modules associated with the test case. The set of logical modules may be retrieved from the logical modules 108. The test case execution module 104 may execute the set of logical modules using the testing information for testing the component.

On being executed by the test case execution module 104, each logical module 108 present in the set of logical modules may execute the instructions included therein to perform a set of predefined tasks. For example, a logical module A, when executed by the test case execution module 104, may read information associated with the computing device and the component to be tested from the testing information. Further instructions included in the logical module A may cause the logical module A to read a configuration file and a library file for facilitating testing of the component. The logical module A may further include instructions for executing a core logic to perform one or more predefined tasks. As a result, one or more steps of the test case may be performed.

For instance, in a test case to test a processor, a test step may involve executing multiple programs on the processor for testing the speed of the processor. In said case, execution of the core logic of a first logical module may cause the logical module to perform one or more tasks, for example, fetching of the programs and triggering the programs on the processor, thereby facilitating execution of the aforementioned test step.

Additional instructions in the logical modules may facilitate recording output related to performance of the component, creation of one or more temporary files, converting the output to a user readable format, and facilitating validation of the output. In an example, the logical modules present in the set may interact with each other for performing the steps of the test case for testing the component.

On execution of the set of logical modules, an output related to operational characteristics of the component may be provided by the computing device. For instance, in the above example, the speed of the processor may be the output of one logical module. The output generated may be recorded in a test log by the test case execution module 104.

The test log generated by the test case execution module 104 may be validated by the validation module 106 using validation data associated with the component. The validation data may include expected output of the component when operated in different states and conditions. Additionally, the validation data may include other specifications of the component. For instance, the validation data may include a model, a name, and a component type of the component. The validation module 106 may obtain the validation data from one or more sources, such as a data source, a user, and the component itself. The data source may be a central repository comprising information associated with the components of the computing device. In another example, the data source may be a database (not shown in the figure) coupled to the system 100.

In an example, the validation module 106 may validate the test log by comparing the test log with the validation data. In said example, the validation module 106 may compare the output generated upon testing the component with the expected output of the component. Based on the comparison, the validation module 106 may ascertain the performance of the component. For instance, in a case where the output generated upon testing is equal to or above a predetermined percentage of the expected output, the validation module 106 may ascertain the performance of the component to be of an acceptable level and may rate the performance as “pass”. On the other hand, if the output generated is below the predetermined percentage of the expected output, the validation module 106 may ascertain the performance of the component to be of an unacceptable level and may rate the performance as “fail”.

In an example, the validation module 106 may rate the performance of the component based on a user input. For instance, the validation module 106 may provide the comparison between the output generated and the expected output to a user. In said example, the validation module 106 may receive the user input indicative of a performance of the component, as determined by the user. Based on the user input, the validation module 106 may then rate the performance of the component. In an example, the validation module 106 may generate a test report based on the rating. The test report may be provided to the user by the validation module 106.

In an example, the test report may further include the comparison between the output generated and an expected output as determined based on the one or more sources. For instance, the test report may include a comparison between a type of a processor as determined by testing the processor and a type of the processor as determined based on information received from the one or more sources. In an example, the validation module 106 may process the information prior to inclusion in the test report for converting the information to a predetermined standard format. For instance, a speed of the processor may be represented in Hertz. In said example, if the information received from a source indicates the speed in Gigahertz, the validation module 106 may convert the speed to Hertz. In another case, the validation module 106 may present the information as received from the source without converting the information.

Thus the system 100 substantially simplifies creation and execution of test cases and validation of test logs. In one example, the system 100 can be implemented in a network environment as discussed below.

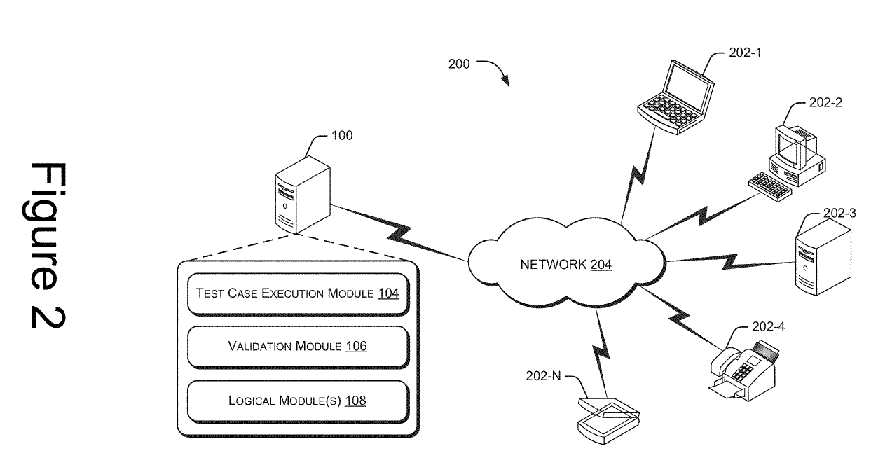

FIG. 2 illustrates a network environment 200 implementing the system 100 for testing computing devices, in accordance with an example of the present subject matter. The network environment 200 includes a plurality of computing devices 202-1, 202-2, 202-3, 202-4, . . . , 202-N, individually referred to as computing device 202 and collectively referred to as computing devices 202, connected to the system 100, through a network 204. Examples of the computing devices 202 may include, but are not limited to, a laptop, a desktop, a server, a mainframe computer, a printer, and a scanner.

The network 204 may be a wireless network, a wired network, or a combination thereof. The network 204 may also be an individual network or a collection of many such individual networks, interconnected with each other and functioning as a single large network, e.g., the Internet or an intranet. The network 204 may be implemented as one of the different types of networks, such as intranet, local area network (LAN), wide area network (WAN), and such. The network 204 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other.

The network 204 may also include individual networks, such as, but are not limited to, Global System for Communication (GSM) network, Universal Telecommunications System (UMTS) network, Long Term Evolution (LTE) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the implementation, the network 204 may include various network entities, such as base stations, gateways and routers; however, such details have been omitted to maintain the brevity of the description. Further, communication between the system 100, the computing devices 202, and other entities may take place based on communication protocol(s) compatible with the network 204.

In an example, a user, for example a tester, may seek to test a computing device, such as the computing device 202-1. In said example, the system 100 may receive a user input, such as testing information, from the user specifying a component of the computing device 202-1 which is to be tested. In response to the user input, the system 100 may provide the user with a list of test cases that may be executed on the component.

In an example, the test cases may be predefined, for example, by an individual or a team of individuals having expertise in the testing domain for testing components of the computing devices 202. To define a test case the individual may associate a set of logical modules with an identity (ID) of the test case. The logical modules may themselves be created by a team of individuals, such as an automation team having expertise in coding and testing. To create a logical module, the automation team can write the instructions for the tasks to be executed by the logical module to perform steps of the test. Thus, the tester, i.e., the user performing the testing, can be a relatively less skilled person and can utilize and reuse the test cases and logical modules created by the more skilled individuals. The process of creating test cases thus becomes more efficient and less error prone.

On being provided with the list of test cases, the user may then select a test case for testing the component. In an example, the system 100 may provide the user with an option to modify the test case. For instance, the system 100 may provide the user with an option to add or drop logical modules from the set of logical modules associated with the test case. In another example, the system 100 may provide the user with an option to create a new test case by selecting one or more logical modules from the available logical modules 108.

Upon selection of the test case by the user, the test case may be executed to test the component. In an example, the test case execution module 104 may retrieve and execute the set of logical modules associated with the test case. In response to the execution of the logical modules, an output related to the component may be generated. The output may be recorded in a test log by the test case execution module 104. Further, the validation module 106 may validate the test log using validation data. For instance, the validation module 106 may compare the test log with the validation data. Based on the comparison, the validation module 106 may rate the component's performance as either “pass” or a “fail”. In an example, the validation module 106 may generate a test report comprising the component's performance. The validation module 106 may then provide the test report to the user.

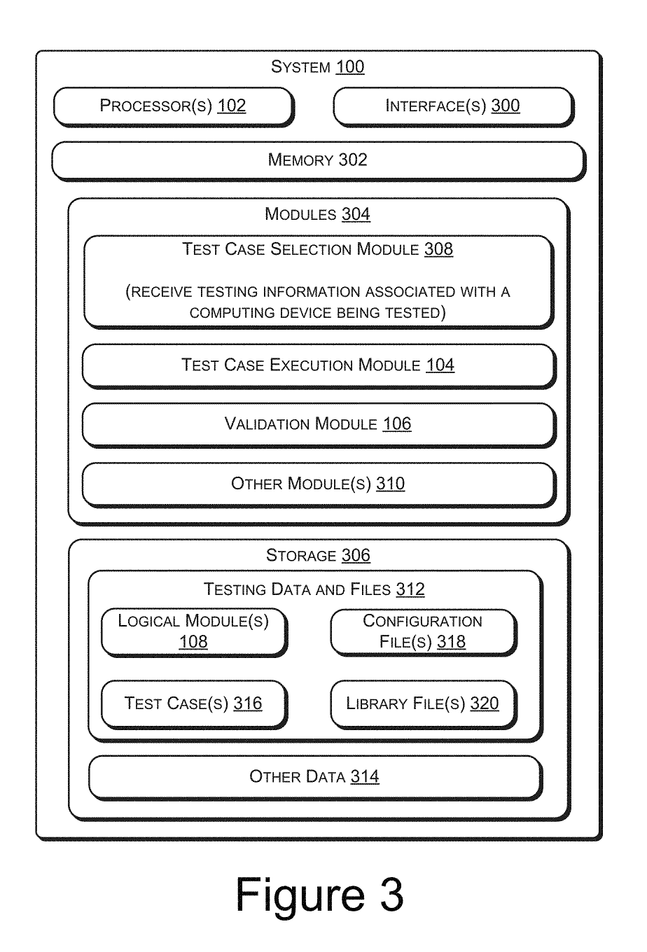

FIG. 3 illustrates components of the system 100 for testing computing devices, according to an example of the present subject matter. In an example, the system 100 includes interface(s) 300. The interface(s) 300 may include a variety of machine readable instructions-based interfaces and hardware interfaces that allow the system 100 to interact with other computing devices, such as the computing devices 202. Further, the interface(s) 300 may enable the system 100 to communicate with other network entities, web servers, and external repositories.

Further, the system 100 includes memory 302 coupled to the processor 102. The memory 302 may include any non-transitory computer-readable medium including, for example, volatile memory (e.g., RAM), and/or non-volatile memory (e.g., EPROM, flash memory, etc.). The system 100 further includes module(s) 304 and storage 306. The module(s) 304, amongst other things, include routines, programs, objects, components, data structures, etc., which perform particular tasks or implement data types. The module(s) 304 further include modules that supplement applications on the system 100, for example, modules of an operating system. The storage 306 serves, amongst other things, as a repository for storing data that may be fetched, processed, received, or generated by the module(s) 304. Although the storage 306 is shown internal to the system 100, it may be understood that the storage 306 can reside in an external repository (not shown in the figure), which may be coupled to the system 100. The system 100 may communicate with the external repository through the interface(s) 300.

In an example, the module(s) 304 of the system 100 includes a test case selection module 308, the test case execution module 104, the validation module 106, and other module(s) 310. In an example, the storage 306 of the system 100 includes testing data and files 312 and other data 314. The testing data and files 312 include logical module(s) 108, test case(s) 316, configuration file(s) 318, and library file(s) 320. In an example, the test cases 316 may include a plurality of test cases for testing one or more components, such as a processor, a motherboard, a fan, a memory, of a computing device, such as the computing device 202. Each test case in the test cases 316 has a set of logical modules associated with it. Further, each logical module 108 includes instructions to perform a set of predefined tasks for testing of the components. The other module(s) 310 may include programs or coded instructions that supplement applications and functions, for example, programs in the operating system of the system 100, and the other data 314 comprise data corresponding to the other module(s) 310.

In an implementation, the test case selection module 308 may receive, from a user, testing information associated with a computing device which is to be tested. For instance, the test case selection module 308 may receive testing information associated with the computing device 202. The testing information, in an example, may include network location information associated with the computing device. The network location information may include, an Internet Protocol (IP) address, a subnet, a Gateway, login credentials, and a network address of a processor of the, of the computing device. Further, the testing information may include other information associated with the computing device. For instance, the testing information may include information about an operating system of the computing device, specifications of a component of the computing device which is to be tested, such as a model and a type of the component, and the like.

In an example, the test case selection module 308 may establish a connection with the computing device based on the testing information for testing the component of the computing device. In an implementation, the test case selection module 308 may provide a list of components of the computing device to a user seeking to test the components of the computing device. In response, the test case selection module 308 may receive a user selection indicative of a component to be tested.

Once the component to be tested is determined, the test case selection module 308 may identify a test case to be executed on the component. A sample test case for validating memory of a virtual machine monitor is provided in Table 1 below.

TABLE 1
Sample Test Case

| | |
|---|---|
| TEST CASE ID | 2371 |

| | |
|---|---|
| TEST CASE | ESXi - CIM Provider - SMX Memory |
| NAME | Validation |
| TEST CASE | “Verify ESX CIM Provider SMX Memory |
| DESCRIPTION | Validation” |

| | |
|---|---|
| TEST CASE OS | ESX |

| | |
|---|---|
| TEST CASE | [ |

| | |
|---|---|
| SEARCH TERMS | “SMX”, |
| | “ESX”, |
| | “CIM Provider”, |
| | “Memory”, |
| | “Validation” |

| | |
|---|---|
| | ] |
| LOGICAL | [ |

| | |
|---|---|
| MODULE(S) | “SMX_RUN(Validation |
| | ,Memory_Validation)” |

]

In the above sample test case, ESX is the virtual machine monitor operating system, the CIM is the common interface model (CIM) facilitating interaction with the ESX, and SMX is the memory. The logical module associated with the above sample test case is “SMX_RUN(Validation,Memory_Validation)”. The instructions included in the SMX_RUN(Validation,Memory_Validation) logical module facilitates validation of the memory.

In an example, the test case selection module 308 may identify the test case for the component based on a type of the component. For instance, in an example where the user may choose to test a processor, the test case selection module 308 may select a test case designed for testing processors from the test cases 316.

In another example, the test case selection module 308 may identify the test case to be executed based on a user input. For instance, the test case selection module 308 may identify a list of pre-defined test cases designed for testing the component based on the type of the component. The test case selection module 308 may then provide the list of pre-defined test cases to the user. The user may then select a test case from the list for testing the component. In an example, the test case selection module 308 may modify the test case based on the user input. For instance, the test case selection module 308 may add or delete one or more logical modules associated with the test case based on the user input.

In yet another example, the test case selection module 308 may create a new test case based on the user input. In said example, the test case selection module 308 may receive a selection of one or more logical modules from the logical modules 108 from the user. Based on the logical modules selected by the user, the test case selection module 308 may create the test case.

Prior to execution of the test case, the test case selection module 308 may perform a pre-test check. In the pre-test check, the test case selection module may verify one or more testing conditions associated with the test case. An example testing condition may include determining a run time environment of the test case. Another example testing condition may include determining whether input data for executing the test case is complete or not. In a case where input data is incomplete, the test case selection module 308 may request the user to provide additional testing information for facilitating execution of the test case. In one example, if the pre-check test is not cleared, the test case selection module 308 may provide an error message to the user stating that the test cannot be executed.

In one example, when the pre-test check is cleared, the test case execution module 104 may retrieve a set of executable logical modules associated with the test case from the logical modules 108. On retrieving the set of logical modules, the test case execution module 104 may analyze the testing information to determine an operating system (OS) of the computing device and a type of the component being tested. Based on the OS and the type of the component, the test case execution module 104 may retrieve at least one configuration file and at least one library file from the configuration files 318 and library files 320, respectively. The configuration file may include detailed specifications of the component, which is to be used for executing the set of logical modules. In one example, the configuration file may be a JavaScript Object Notation (JSON) file that provides the specifications of the component to be tested as data objects. Thus, the same logical module may be used to test different components by using different configuration files. In an example, the test case execution module 104 may obtain the specifications of the component from the at least one configuration file. A library file may include instructions for a commonly used functionality that is to be included in several logical modules. For example, a library file may include instructions for reading a JSON file, another library file may include instructions for reading the testing information, and yet another library file may include instructions for writing the output generated on the execution of a logical module. The at least one library file may be executed by the test case execution module 104 for executing the set of logical modules, in an example.

On retrieving the set of logical modules, configuration files and library files, the test case execution module 104 may execute the set of logical modules using the configuration file and the library file for testing the component. As described earlier in the description of FIG. 1, each logical module 108, when executed, executes instructions included therein to perform a set of predefined tasks thereby, facilitating testing of the component. Upon execution of the set of logical modules, an output may be generated. For instance, in a case where a test for determining a type of the processor is being performed, the output may include a type of the processor as determined, for example, from an operating system operating on the processor. The test case execution module 104 may generate a test log comprising the output generated.

Once the test log is generated, the validation module 106 may validate the test log by comparing the test log with validation data associated with the component. The validation data may include an expected output of the component when operated in one or more states and conditions. For instance, in the above example, the expected output may include an actual type of the processor as determined based on information provided by a manufacturer of the processor. Based on the comparison, the validation module 106 may rate the component's performance as either “pass” or fail”. In an example, the validation module 106 may rate the component's performance based on a user input.

In an example, the validation module 106 may generate a test report comprising the component's performance based on the validation. In said example, the test report may also include the comparison between the output generated by the component and the expected output of the component. In an example, the user may analyze or modify the test report.

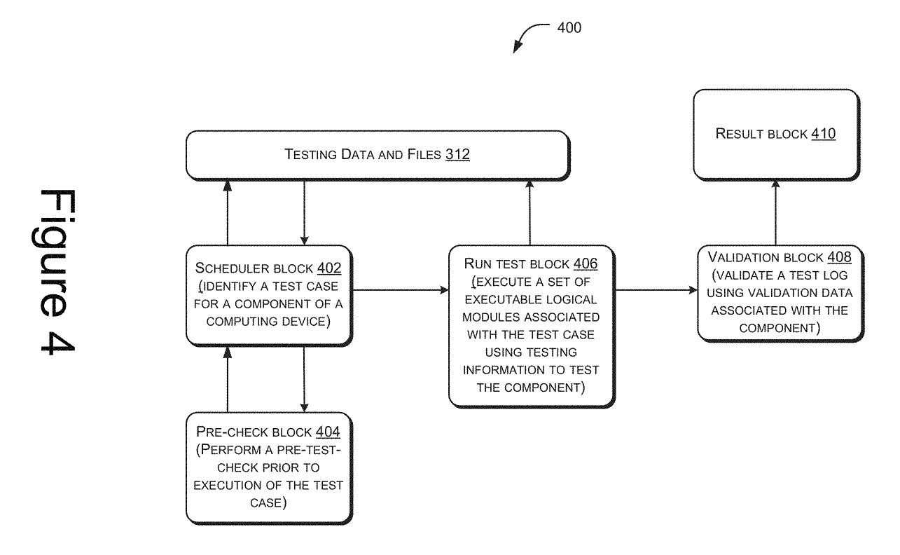

FIG. 4 illustrates a framework 400 for testing computing devices, according to an example of the present subject matter. In an example, the framework 400 may be implemented in a computing device, such as the system 100, for testing components of a computing device, such as the computing device 202.

In an implementation, the framework 400 includes a scheduler block 402, a pre-check block 404, a run test block 406, a validation block 408, and a result block 410, collectively referred to as blocks 402-410, for testing a component of a computing device. Examples of the component that may be tested may include, but are not limited to, a processor, a motherboard, memory, a fan, and a port. In an example, the functionalities of the blocks 402-410, as described herein, may be implemented using one or more modules, such as the modules 304.

In an example, for testing the component, the blocks 402-410 may access storage of the computing device on which the framework 400 is to be implemented. The storage may include data, such as testing data and files 312, for facilitating testing of the components.

In operation, the scheduler block 402 may access the testing data and files 312 to identify a test case to be run on the component. The testing data and files 312, as described earlier, include a plurality of test cases designed for testing components of computing devices. In an example, for identifying the test case, the scheduler block 402 may present the user with a list of test cases in response to which the user may select a test case to be executed on the component. In another example, the scheduler block 402 may provide the user with an option of creating a new test case. In yet another example, the scheduler block 402 may identify the test case based on the type of the component.

Once the test case to be executed is identified, the pre-check block 404 may perform a pre-test check prior to execution of the test case. The pre-test check may involve testing one or more conditions associated with the test case. Once the pre-check test has been performed, the pre-check block 404 may transmit a trigger to the scheduler block 402 to initiate the test case.

On receiving the trigger, the scheduler block 402 may communicate with the run test block 406 to initiate the test case. In an example, the run test block 406 may retrieve and execute a set of executable logical modules associated with the test case for testing the component. The set of logical modules may be selected from a plurality of logical modules, such as the logical modules 108. As a result of the execution of the set of logical modules, an output may be generated and recorded in a test log.

In an example, the validation block 408 may validate the test log for ascertaining a performance of the component using validation data. For instance, the validation block 408 may compare the test log and the validation data for validating the test log. Once the test log has been validated, the result block 410 may generate a test report for being provided to a user, for example, a tester.

Example test cases that may be executed by the framework 400 are provided below.

### Example Test Cases

### Example Test Case 1

| | |
|---|---|
| TEST CASE ID | 001 |

| | |
|---|---|
| TEST CASE | Testing speed of a central processing unit (CPU) |

| | |
|---|---|
| NAME | |
| LOGICAL | [ |

| | |
|---|---|
| MODULE(S) | “CPU_RUN(CPU, Speed)”, |
| | “OS_Validation(CPU, Speed)” |
| | “iLO_Validation(CPU, Speed)” |
| | “UserData_Validation(CPU, Speed)” |
| | “PreOS_Validation(CPU, Speed)” |

]

### Example Test Case 2

| | |
|---|---|
| TEST CASE ID | 002 |

| | |
|---|---|
| TEST CASE | Testing size of memory |

| | |
|---|---|
| NAME | |
| LOGICAL | [ |

| | |
|---|---|
| MODULE(S) | “Memory_RUN(Memory , Size)”, |
| | “OS_Validation(Memory, Size)” |
| | “iLO_Validation(Memory, Size)” |
| | “UserData_Validation(Memory, Size)” |
| | “PreOS_Validation(Memory, Size)” |

]

As illustrated above, each of the test cases 1 and 2 includes a test case identity (ID) and an objective. For instance, test case 1, having ID 001, is for testing speed of a CPU, while, test case 2, having ID 002, is for testing size of memory. In an example, the framework 400 may execute the test case 1 for testing the speed of a CPU of a computing device. In order to execute the test case 001, the run test block 406 may execute the associated logical modules “CPU_RUN”, “OS_Validation”, “iLO_Validation”, “UserData_Validation”, and “PreOS_Validation”. The “CPU_RUN” logical module, when executed, includes instructions to test the speed of the CPU. The “OS_Validation” logical module, when executed, includes instructions to obtain the speed of the CPU recorded at OS level. The “iLO_Validation”, “UserData_Validation”, and “PreOS_Validation” logical modules include instructions to obtain the speed of the CPU from one or more sources, such as a user and the processor. The speed obtained from the sources may be compared with the speed recorded at the OS level to ascertain a performance of the CPU.

Similarly, the framework 400 executes the test case 2 in a case where size of the memory is to be tested. In said case, the run test block 406 may execute the set of logical modules associated with the test case 002 for testing the size of the memory. As illustrated above, the set may include “Memory_RUN”, “OS_Validation”, “iLO_Validation”, “UserData_Validation”, and “PreOS_Validation”. As can be seen, same logical modules are being used for testing different components. Thus, the present subject matter provides for a dynamic approach of creating test cases and testing the components of a computing device.

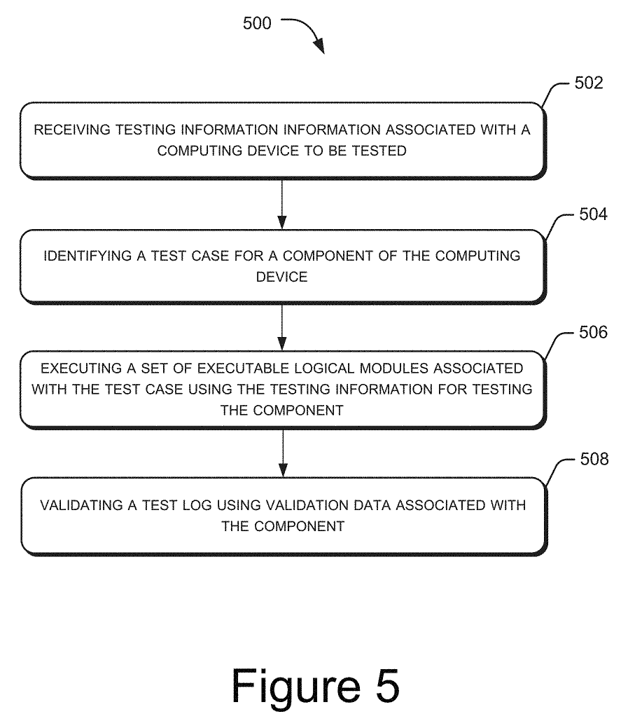

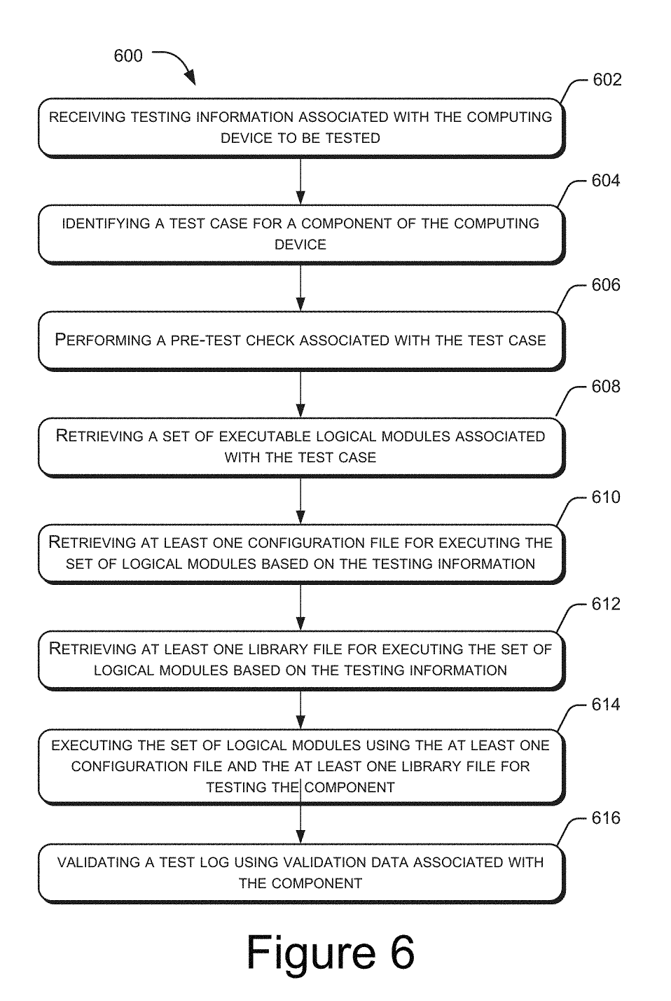

FIG. 5 illustrates a method 500 for testing computing devices, according to an example of the present subject matter. FIG. 6 illustrates a method 600 for testing computing devices, according to an example of the present subject matter. The order in which the methods 500 and 600 are described is not intended to be construed as a limitation, and any number of the described method blocks can be combined in any order to implement methods 500 and 600, or an alternative method. Additionally, individual blocks may be deleted from the methods 500 and 600 without departing from the spirit and scope of the subject matter described herein. Furthermore, the methods 500 and 600 may be implemented in any suitable hardware, machine readable instructions, firmware, or combination thereof.

A person skilled in the art will readily recognize that steps of the methods 500 and 600 can be performed by programmed computers. Herein, some examples are also intended to cover program storage devices and non-transitory computer readable medium, for example, digital data storage media, which are machine or computer readable and encode machine-executable or computer-executable instructions, where said instructions perform some or all of the steps of the described methods 500 and 600. The program storage devices may be, for example, digital memories, magnetic storage media, such as magnetic disks and magnetic tapes, hard drives, or optically readable digital data storage media.

With reference to method 500, as illustrated in FIG. 5, at block 502, testing information associated with a computing device to be tested is received. In an example, the testing information may be received from a user, for example, a tester seeking to test components of the computing device. The testing information may include network location information associated with the computing device. For example, the testing information may include an Internet Protocol (IP) address, a subnet, a gateway, login credentials, and/or an Integrated Lights-Out (iLO) address of the computing device. Based on the network location information included in the testing information, a system deployed for testing the components may establish a connection and gain access to the computing device for performing one or more tests on the components.

The testing information may further include other information, such as information about an operating system of the computing device, a type and a model of the component, and other information associated with a component which is to be tested. In an example, the test case selection module 308 may receive the testing information for testing the computing device.

At block 504, a test case for a component of the computing device is identified. As mentioned above, the component to be tested may be determined based on the testing information. In an example, the test case to be executed on the component may be identified based on a user input. In another example, the test case may be identified based on a type of the component. In an implementation, the test case selection module 308 may identify the test case to be run on the computing device.

At block 506, a set of executable logical modules associated with the test case is executed using the testing information for testing the component. The set of logical modules associated with the test case may be retrieved from a plurality of logical modules, such as the logical modules 108, stored in a data source coupled to the system. For executing the logical modules, at least one configuration file and at least one library file may be retrieved based on the operating system of the computing device and the component to be tested. In an example, the configuration files and the library files may be retrieved from a data source, such as the test and files data 312.

As mentioned above, each logical module comprises instructions to perform a set of tasks. On being executed by the system, the logical module performs the set of tasks on the component for testing the component. In an example, the test case execution module 104 may execute the set of logical modules for testing the component.

At block 508, a test log is validated using validation data associated with the component. In response to the execution of the set of logical modules on the component, the component may generate an output. The output may be included in the test log. The validation data may indicate the component's expected performance output in response to various testing scenarios or conditions. In addition, the validation data may include information about one or more attributes, such as a type, a model, and an operating system of the component. The validation data may be obtained from various resources, such as a user, a data source, and the component itself. In an example, the validation may be done by comparing the output logged in the test log with component's expected performance output. In a case where the output is at par or above the component's expected performance output, the component's performance is rated as “pass”. On the other hand, where the component's performance is below the component's expected performance output, the component's performance is rated as “fail”.

In an example, a test report, including the component's performance may be generated and subsequently provided to a user, for example, a tester.

With reference to method 600 as illustrated in FIG. 6, at block 602, testing information associated with a computing device to be tested is received. The testing information may include network location information associated with the computing device. For instance, the testing information may include an Internet Protocol (IP) address and a gateway associated with the computing device. The testing information may further include other information, such as an OS supported by the computing device. Further, the testing information may include a type and model of a component which is to be tested. In an example, the test case selection module 308 may receive the testing information.

At block 604, a test case for a component of the computing device is identified. As explained above with reference to FIG. 3, in an example, the test case may be identified based on a type of the component. In another example, the test case may be identified based on a user input. The component to be tested is determined based on the testing information. In an implementation, the test case selection module 308 may identify the test case to be run on the component.

At block 606, a pre-test check associated with the test case is performed. The pre-test check includes verifying one or more testing conditions associated with the test case. An example testing condition may include verifying the operating environment in which the test case is to be executed. In an example, the test case selection module 308 may perform the pre-test check.

At block 608, a set of executable logical modules associated with the test case is retrieved. In an example, the test case execution module 104 may retrieve the set of logical modules from a plurality of logical modules, such as the logical modules 108. Each logical module may include instructions that, when executed, perform a set of predefined tasks for testing the component.

At block 610, at least one configuration file for executing the set of logical modules is retrieved based on the testing information. In an example, the at least one configuration file may be retrieved from a data source, such as the configuration files 318, based on a type of the OS of the computing device and a type of the component. The configuration file may include a tool for executing the set of logical modules. Once the configuration file is retrieved, specifications of the component may be obtained from the configuration file. In an example, the test case execution module 104 may retrieve the configuration file 318 based on the testing information.

At block 612, at least one library file for executing the set of logical modules is retrieved based on the testing information. In an example, the test case execution module 104 may retrieve the at least one library file from the library files 320 based on the testing information. In an example, the at least one library file may be retrieved based on the type of the component and the OS of the computing device. Thereafter, the library file may be executed for executing the set of logical modules.

At block 614, the set of logical modules is executed using the at least one configuration file and the at least one library file for testing the component. On being executed, each of the set of logical modules may perform a set of tasks for testing the component. In an example, the test case execution module 104 may execute the set of logical modules to generate the test log.

At block 616, a test log is validated using validation data associated with the component. The test log may include an output generated upon execution of the set of logical modules. The validation data may indicate an expected output of the component in response to various testing scenarios or conditions. In addition, the validation data may include information about one or more attributes, such as a type, a model, and an operating system supported, of the component. The validation data may be obtained from various resources, such as a user, a data source, and the component itself. In an example, the validation may be done by comparing the output logged in the test log with component's expected performance output.

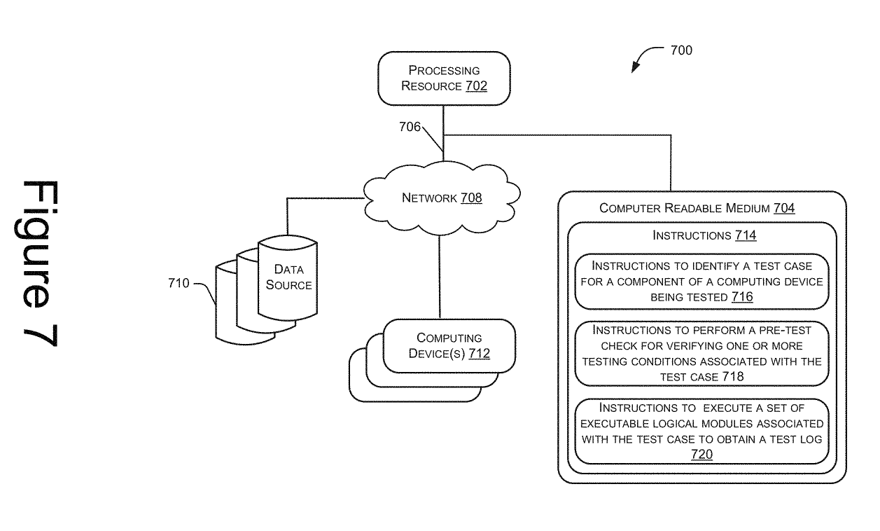

FIG. 7 illustrates an example network environment implementing a non-transitory computer readable medium for testing computing devices, according to an example of the present disclosure. The system environment 700 may comprise at least a portion of a public networking environment or a private networking environment, or a combination thereof. In an implementation, the system environment 700 includes a processing resource 702 communicatively coupled to a non-transitory computer readable medium 704 through a communication link 706.

In an example, the processing resource 702 may include one or more processors of a computing device, such as the system 100 as described earlier, for testing computing devices. The non-transitory computer readable medium 704 can be, for example, an internal memory device of the computing device or an external memory device. In an implementation, the communication link 706 may be a direct communication link, such as any memory read/write interface. In another implementation, the communication link 706 may be an indirect communication link, such as a network interface. In such a case, the processing resource 702 can access the non-transitory computer readable medium 704 through a network 708. The network 708 may be a single network or a combination of multiple networks and may use a variety of different communication protocols.

The processing resource 702 and the non-transitory computer readable medium 704 may also be coupled to data sources 710 through the communication link 706, and/or to computing devices 712 over the network 708. The coupling with the data sources 710 enables receiving requested data in an offline environment, and the coupling with the computing devices 712 enables receiving the requested data in an online environment.

In an implementation, the non-transitory computer readable medium 704 includes a set of computer readable instructions for testing computing devices. The set of computer readable instructions, referred to as instructions 714 hereinafter, can be accessed by the processing resource 702 through the communication link 706 and subsequently executed to test one or more components of a computing device.

In an example, referring to FIG. 7, the instructions 714 include instructions 716 that cause the processing resource 702 to identify a test case for a component of a computing device being tested based on at least one of a user input and a type of the component. In an example, where the test case is identified based on the user input, the instructions 714 may include instructions that cause the processing resource 702 to provide a list of pre-defined test cases to a user based on the type of the component for identifying the test case to be executed. In an example, a set of logical modules is associated with the test case such that each logical module in the set of logical modules comprises a set of predefined tasks.

The instructions 714 further include instructions 718 that cause the processing resource 702 to perform a pre-test check for verifying one or more testing conditions associated with the test case. An example testing condition may include verifying an operating environment in which the testing of the component may be performed.

Further, the instructions 714 include instructions 720 that cause the processing resource 702 to execute the set of logical modules using testing information to obtain a test log. In one example, for executing the set of logical modules, the instructions 714 may further include instructions that cause the processing resource 702 to obtain specifications of the component from at least one configuration file. The processing resource 702 may determine the at least one configuration file based on the testing information. Further, in said example, the instructions 714 may include instructions that cause the processing resource 702 to execute at least one library file for executing the set of logical modules. In an example, the processing resource 702 may, determine the at least one library file based on the testing information.

The testing information may include information associated with an operating system of the computing device and information associated with the component to be tested. The test log may include an output generated upon the execution of the set of logical modules.

In one example, the instructions 714 may include instructions that cause the processing resource 702 to validate the test log using validation data associated with the component.

Although examples for testing computing devices have been described in language specific to structural features and/or methods, it is to be understood that the appended claims are not limited to the specific features or methods described. Rather, the specific features and methods are disclosed as examples for testing computing device.

We claim:

1. A system comprising:
a processor;
a test case execution module coupled to the processor, wherein the test case execution module is to,
retrieve a set of executable logical modules associated with a test case for a component of a computing device being tested, wherein each logical module in the set of logical modules comprises instructions that, when executed, perform a set of predefined tasks for testing the component; and
execute the set of logical modules using testing information for testing the component, wherein the testing information comprises network location information associated with the computing device; and
a validation module coupled to the processor, wherein the validation module is to validate a test log using validation data associated with the component, wherein the test log comprises an output generated upon the execution of the set of logical modules.

2. The system as claimed in claim 1, wherein the system further comprises a test case selection module coupled to the processor to:
receive the testing information associated with the computing device, wherein the testing information further comprises information associated with an operating system of the computing device and information associated with the component to be tested;
establish a connection with the computing device based on the testing information; and
identify the test case to be executed on the component.

3. The system as claimed in claim 2, wherein the test case selection module further identifies the test case based on at least one of a user input and a type of the component.

4. The system as claimed in claim 2, wherein the test case selection module further is to
receive a selection of one or more logical modules from the user; and
create the test case based on the one or more logical modules selected by the user.

5. The system as claimed in claim 1, wherein the test case execution module further is to:
obtain specifications of the component from at least one configuration file, wherein the at least one configuration file is determined based on the testing information; and
execute at least one library file for executing the set of logical modules wherein the at least one library file is determined based on the testing information.

6. A method comprising:
receiving testing information associated with a computing device to be tested, wherein the testing information comprises network location information associated with the computing device;
identifying a test case for a component of the computing device, wherein a set of logical modules is associated with the test case, and wherein each logical module in the set of logical modules comprises instructions that, when executed, performs a set of predefined tasks for testing the component;
executing the set of logical modules using the testing information for testing the component; and
validating a test log using validation data associated with the component, wherein the test log comprises an output generated upon the execution of the set of logical modules.

7. The method as claimed in claim 6, wherein the testing information further comprises information associated with an operating system of the computing device and information associated with the component to be tested.

8. The method as claimed in claim 6, wherein the test case is identified based on at least one of a user input and a type of the component.

9. The method as claimed in claim 7, wherein the executing the set of logical modules further comprises:
obtaining specifications of the component from at least one configuration file, wherein the at least one configuration file is determined based on the testing information; and
executing at least one library file for executing the set of logical modules wherein the at least one library file is determined based on the testing information.

10. The method as claimed in claim 6, wherein the method further comprises performing a pre-test check to verify one or more testing conditions associated with the test case.

11. A non-transitory computer readable medium having a set of computer readable instructions that, when executed, cause a processor to:
identify a test case for a component of a computing device being tested based on at least one of a user input and a type of the component, wherein a set of logical modules is associated with the test case, and wherein each logical module in the set of logical modules comprises instructions that, when executed, performs a set of predefined tasks for testing the component;
perform a pre-test check for verifying one or more testing conditions associated with the test case; and
execute the set of logical modules using testing information to obtain a test log, wherein the testing information comprises network location information associated with the computing device, and wherein the test log comprises an output generated upon execution of the set of logical modules.

12. The non-transitory computer readable medium as claimed in claim 11, wherein the testing information further comprises information associated with an operating system of the computing device and information associated with the component to be tested.

13. The non-transitory computer readable medium as claimed in claim 12 further comprising instructions that, when executed, cause the processor to,
obtain specifications of the component from at least one configuration file, wherein the at least one configuration file is determined based on the testing information; and
execute at least one library file for executing the set of logical modules wherein the at least one library file is determined based on the testing information.

14. The non-transitory computer readable medium as claimed in claim 11 further comprising instructions that, when executed, cause the processor to validate the test log using validation data associated with the component.

15. The non-transitory computer readable medium as claimed in claim 11 further comprising instructions that, when executed, cause the processor to provide a list of pre-defined test cases to a user based on the type of the component for identifying the test case to be executed.
